(19) United States
(12) Patent Application Publication
(10) Pub. No.: US 2023/0039705 A1
(43) Pub. Date: Feb. 9, 2023

(54) DECORATIVE SHEET FOR VACUUM FORMING, METHOD FOR PRODUCING DECORATIVE MATERIAL, AND DECORATIVE MATERIAL

(71) Applicant: DAI NIPPON PRINTING CO., LTD., Tokyo (JP)

(72) Inventors: Natsuo SUGITA, Tokyo (JP); Koki FUJII, Tokyo (JP); Kosuke NAKAI, Tokyo (JP); Takaho SAITO, Tokyo (JP)

(73) Assignee: DAI NIPPON PRINTING CO., LTD., Tokyo (JP)

(21) Appl. No.: 17/790,319

(22) PCT Filed: Feb. 24, 2021
(86) PCT No.: PCT/JP2021/006876

§ 371 Date: Jun. 30, 2022

(30) Foreign Application Priority Data
Mar. 31, 2020 (JP) 2020-065219

(51) Int. Cl. B32B 3/30; B32B 27/08; B32B 27/30; B32B 27/20; B32B 37/10; B32B 37/06

(52) U.S. Cl. CPC B32B 3/30; B32B 27/08; B32B 27/304; B32B 27/20; B32B 37/1018; B32B 37/06; B32B 2255/10; B32B 2264/104; B32B 2307/402; B32B 2327/06; B32B 2451/00

(57) ABSTRACT

A decorative sheet for vacuum forming is difficult to peel off during vacuum forming between a first vinyl chloride-based resin layer and a second vinyl chloride-based resin layer and can give a design of various colors. This decorative sheet for vacuum forming includes: a first vinyl chloride-based resin layer containing a vinyl chloride-based resin and a coloring agent; and a second vinyl chloride-based resin layer which is laminated on the first vinyl chloride-based resin layer, contains a vinyl chloride-based resin, and is transparent, wherein the content of titanium oxide particles of the coloring agent is less than 1 part by mass, the first vinyl chloride-based resin layer contains inorganic particles, and at least some of the inorganic particles are calcium carbonate particles.

### TECHNICAL FIELD

The present disclosure relates to a decorative sheet for vacuum forming and the like.

### BACKGROUND ART

Decorative materials are used as building materials such as construction materials or fittings for houses. The decorative sheet is a sheet for imparting a design to the surface of a decorative material (for example, Patent Document 1).

Vacuum forming is known as one of the methods for imparting a design to a three-dimensional decorative material using a decorative sheet. The method of producing a decorative material by the vacuum forming method is a method for forming a decorative sheet having a three-dimensional shape following the shape of the substrate and adhering the resulting decorative sheet to the substrate. The method includes softening the decorative sheet by heating, and allowing the substrate to vacuum-adsorb the softened decorative sheet through a pressure reducing operation. As the substrate, for example, a wooden board such as plywood, a wooden fiber board, or a particle board; a plastic board; or a metal board is used. The decorative sheet for vacuum forming is a decorative sheet for decorating a substrate by vacuum forming. The decorative material is decorated with a decorative sheet and used as a material for houses or fittings.
Patent Document 1: Japanese Unexamined Patent Application, Publication No. 2009-96061

### DISCLOSURE OF THE INVENTION

### Problems to be Solved by the Invention

With the decorative sheet, good design can be expressed, for example, by providing a colored layer or laminating a layer serving as a picture on a layer serving as a foundation. It is considered to use titanium oxide particles as a coloring agent for the colored layer or the layer serving as a foundation of the decorative sheet. Titanium oxide particles constitute a main component of a white pigment called titanium white, and are excellent from the viewpoints of hiding property, non-toxicity, price, and the like, and are therefore suitable as a material for coloring in whitish colors and a material for forming a foundation for pictures.

In recent years, various color designs have been, however, required for decorative materials due to people's diversified preferences. When titanium oxide particles are used as a main component in a coloring agent in a coloring layer or a foundation layer, it is difficult to express, for example, a dark color design because whiteness of titanium oxide particles is high. Therefore, in order to express designs including various colors such as dark colors, it is considered to use a coloring agent other than titanium oxide particles, without using titanium oxide particles. In addition, it is required to reduce a used amount of titanium oxide particles and use a combination of titanium oxide particles and a coloring agent other than titanium oxide particles.

In order to improve durability of a decorative material, the decorative sheet is required to protect the colored layer, the layer serving as a picture, or the layer serving as a foundation from rubbing or poking. Further, in order to adhere the decorative sheet in a three-dimensional shape following that of the base material during vacuum forming, the decorative sheet for vacuum forming is required to be extendable in the planar direction during vacuum forming.

Given the above, the inventors of the present invention have conceived of satisfying the above-mentioned requirements by using a laminate of a first vinyl chloride-based resin layer and a second vinyl chloride-based resin layer in the decorative sheet for vacuum forming; the first vinyl chloride-based resin layer containing a vinyl chloride-based resin and a coloring agent; the first vinyl chloride-based resin layer containing no titanium oxide particles, or a content of titanium oxide particles in the first vinyl chloride-based resin layer being suppressed to less than 1 part by mass; and the second vinyl chloride-based resin layer containing a vinyl chloride-based resin likewise to the first vinyl chloride-based resin layer.

However, it was found that the above idea alone may cause a phenomenon in which delamination occurs between the first vinyl chloride-based resin layer and the second vinyl chloride-based resin layer during vacuum forming. This problem did not occur when a vinyl chloride-based resin layer colored only with titanium oxide particles or a vinyl chloride-based resin layer colored mainly with titanium oxide particles was used as the first vinyl chloride-based resin layer. This problem is specific to a case in which a vinyl chloride-based resin layer containing no titanium oxide particles but a coloring agent other than titanium oxide particles, or a vinyl chloride-based resin layer containing a combination of titanium oxide particles with a coloring agent other than titanium oxide particles is used as the first vinyl chloride-based resin layer. Furthermore, there was no particular problem as long as such a sheet was not used in the vacuum forming method, but used as an ordinary decorative sheet. This problem is specific to the decorative sheet for vacuum forming.

It is an object of the present disclosure to provide a decorative sheet for vacuum forming which does not easily delaminate between a first vinyl chloride-based resin layer and a second vinyl chloride-based resin layer during vacuum forming, and which can impart various color designs. Another object of the present disclosure is to provide a decorative material to which various color designs are given by a vacuum forming method, or a method for producing the same.

### Means for Solving the Problems

One of the decorative sheets for vacuum forming of the present disclosure includes a first vinyl chloride-based resin layer containing a vinyl chloride-based resin and a coloring agent, and a second vinyl chloride-based resin layer being laminated on the first vinyl chloride-based resin layer and containing a vinyl chloride-based resin. The first vinyl chloride-based resin layer does not contain titanium oxide particles or contains titanium oxide particles in a content of less than 1 part by mass, the first vinyl chloride-based resin layer contains inorganic particles, and at least a portion of the inorganic particles are calcium carbonate particles.

One of the methods for producing a decorative material of the present disclosure is a method for producing a decorative material including: providing a base material formed into a three-dimensional shape and a decorative sheet for vacuum forming of the present disclosure; softening the decorative sheet by heating; and allowing the softened decorative sheet to be vacuum-adsorbed by the base material into the three-dimensional shape of the base material through a pressure reducing operation.

One of the decorative materials of the present disclosure is a decorative material including a base material formed into a three-dimensional shape and the decorative sheet for vacuum forming of the present disclosure, the decorative sheet being bonded in a three-dimensional shape following that of the base material. The second vinyl chloride-based resin layer of the decorative sheet for vacuum forming, the first vinyl chloride-based resin layer of the decorative sheet for vacuum forming, and the base material are laminated in this order.

### Effects of the Invention

In the present disclosure, since one of the decorative sheets for vacuum forming includes the first vinyl chloride-based resin layer containing inorganic particles and at least a portion of the inorganic particles are calcium carbonate particles, bonding strength between the first vinyl chloride-based resin layer and the second vinyl chloride-based resin layer is increased. Therefore, it is possible to provide a decorative sheet for vacuum forming which does not easily delaminate between the first vinyl chloride-based resin layer and the second vinyl chloride-based resin layer even during vacuum forming in which the sheet is elongated, this enabling various color designs to be imparted. In addition, it is possible to provide a decorative material to which various color designs are provided by the vacuum forming method, or a method of producing the same.

### BRIEF DESCRIPTION OF THE DRAWINGS

FIG. 1 is a schematic drawing illustrating an embodiment of a decorative sheet for vacuum forming by the present disclosure;

FIG. 2 is a diagram comparing the Examples of the decorative sheet 10 for vacuum forming of the present embodiment with the Comparative Examples;

FIG. 3 is a photograph of a delamination surface of a second vinyl chloride-based resin layer 13 after delamination in Example 2; and

FIG. 4 is a photograph of a delamination surface of the second vinyl chloride-based resin layer 13 after delamination in Comparative Example 1.

### PREFERRED MODE FOR CARRYING OUT THE INVENTION

Hereinafter, embodiments of the present disclosure will be described with reference to the drawings.

A first aspect relates to a decorative sheet (10) for vacuum forming, including a first vinyl chloride-based resin layer (11) including a vinyl chloride-based resin and a coloring agent, and a second vinyl chloride-based resin layer (13) being laminated on the first vinyl chloride-based resin layer (11) and including a vinyl chloride-based resin. The first vinyl chloride-based resin layer (11) of the decorative sheet (10) for vacuum forming contains no titanium oxide particles or a content of titanium oxide particles is less than 1 part by mass. The first vinyl chloride-based resin layer (11) contains inorganic particles (11a), and at least a portion of the inorganic particles (11a) are calcium carbonate particles.

A second aspect relates to the decorative sheet (10) for vacuum forming as described in the first aspect, in which a surface of the first vinyl chloride-based resin layer (11), the surface being closer to the second vinyl chloride-based resin layer (13), has protrusions (11b) caused by inclusion of the inorganic particles (11a) and at least a portion of the protrusions (11b) encroach into the second vinyl chloride-based resin layer (13).

A third aspect relates to the decorative sheet (10) for vacuum forming as described in the first or second aspect, in which a picture layer (12) is disposed between the first vinyl chloride-based resin layer (11) and the second vinyl chloride-based resin layer (13)

A fourth aspect relates to the decorative sheet (10) for vacuum forming as described in any one of the first to third aspects, in which the first vinyl chloride-based resin layer (11) contains 8 parts by mass or more of the inorganic particles (11a) with respect to a resin component.

A fifth aspect relates to the decorative sheet (10) for vacuum forming as described in the fourth aspect, in which the first vinyl chloride-based resin layer (11) contains 3 parts by mass or more of the calcium carbonate particles with respect to the resin component.

A sixth aspect relates to the decorative sheet (10) for vacuum forming as described in the fourth or fifth aspect, in which the first vinyl chloride-based resin layer (11) contains 16 parts by mass or less of the inorganic particles (11a) with respect to the resin component.

A seventh aspect relates to the decorative sheet (10) for vacuum forming as described in the sixth aspect, in which the first vinyl chloride-based resin layer (11) contains 11 parts by mass or less of the calcium carbonate particles with respect to the resin component.

An eighth aspect relates to a method for manufacturing a decorative material, the method including: providing a base material formed into a three-dimensional shape and the decorative sheet (10) as described in any one of the first to seventh aspects; softening the decorative sheet by heating, and allowing the softened decorative sheet to be vacuum-adsorbed by the base material into the three-dimensional shape of the base material through a pressure reducing operation.

A ninth aspect relates to a decorative material including a base material formed into a three-dimensional shape and the decorative sheet (10) for vacuum forming as described in any one of the first to seventh aspects, the decorative sheet (10) being bonded following the three-dimensional shape of the base material, the second vinyl chloride-based resin layer (13) of the decorative sheet (10) for vacuum forming, the first vinyl chloride-based layer (11) of the decorative sheet for vacuum forming, and the base material being laminated in this order.

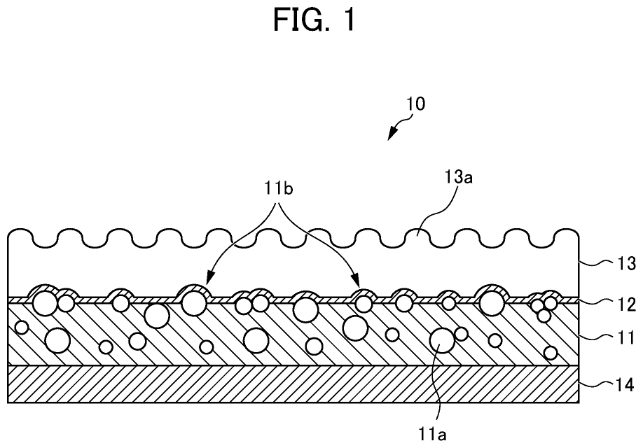

FIG. 1 is a schematic drawing illustrating an embodiment of the decorative sheet for vacuum forming according to the present invention. Note that each drawing shown below including FIG. 1 is a schematic diagram, and the size and shape of each part are appropriately exaggerated or omitted for easy understanding. In the following description, specific numerical values, shapes, materials, and the like will be described, but these may be changed as appropriate.

The decorative sheet 10 for vacuum forming shown in FIG. 1 has a first vinyl chloride-based resin layer 11, a picture layer 12 and a second vinyl chloride-based resin layer 13 are laminated on one side of the first vinyl chloride-based resin layer 11, and a primer layer 14 is laminated on the other side of the first vinyl chloride-based resin layer 11. Note that the picture layer 12 and the primer layer 14 may be provided as needed, as will be described later. The decorative sheet 10 for vacuum forming is suitable for use in a method for producing a decorative material using the vacuum forming method. A known technique can be used as the method for producing a decorative material by a vacuum forming method using the decorative sheet 10 for vacuum forming. The first vinyl chloride-based resin layer 11 is disposed on the substrate side of the decorative material, and the second vinyl chloride-based resin layer 13 is disposed on the surface side of the decorative material.

The first vinyl chloride-based resin layer 11 includes a vinyl chloride-based resin, a coloring agent, and inorganic particles 11a, and at least a portion of the inorganic particles 11a are calcium carbonate particles. Since calcium carbonate particles have a relatively small influence on the color of the first vinyl chloride-based resin layer, calcium carbonate particles are suitable for adding a desired amount of particles while suppressing the influence on the color of the decorative sheet. Calcium carbonate particles having an average particle diameter of 0.1 μm to 1 μm can be used. The inorganic particles 11a may be contained in an amount of 2 parts by mass or more with respect to the resin component, and may be contained in an amount of 18 parts by mass or less. The inorganic particles 11a may be contained in an amount of 8 parts by mass to 16 parts by mass with respect to the resin component. All of the inorganic particles 11a may be calcium carbonate particles, or a portion of the inorganic particles 11a may be calcium carbonate particles. When inorganic particles are contained as a coloring agent or an additive, an amount of the calcium carbonate particles can be reduced, and calcium carbonate particles can be contained in an amount of 2 parts by mass or more and 18 parts by mass or less with respect to the resin component. The calcium carbonate particles may be contained in an amount of from 3 parts by mass to 11 parts by mass with respect to the resin component.

The first vinyl chloride-based resin layer 11 does not contain titanium oxide particles, or the content of titanium oxide particles is less than 1 part by mass. Thereby, it is possible to suppress the influence of the highly opaque white color of titanium oxide particles on the color of the decorative sheet. As the coloring agent, known organic pigments or inorganic pigments can be used. When inorganic pigment particles are used as the coloring agent, the inorganic pigment particles can serve as both the coloring agent and the inorganic particles. The first vinyl chloride-based resin layer may further contain various additives such as a plasticizer, a thermo stabilizer, a light stabilizer, and an ultraviolet light absorbing agent, if necessary.

Examples of the vinyl chloride-based resin include the following resins.

(1) A homopolymer of vinyl chloride monomer.

In a narrow sense, it is sometimes referred to as a vinyl chloride resin (polyvinyl chloride). The average degree of polymerization is, for example, about 900 to 2500.

(2) Chlorinated polyvinyl chloride.
(3) A vinyl chloride copolymer obtained by copolymerizing a vinyl chloride monomer and another monomer copolymerizable with the vinyl chloride monomer at a copolymerization ratio of 50 mol % or less. Examples of other monomers include vinyl acetate, ethylene, vinylidene chloride, vinyl fluoride, acrylonitrile, styrene, methyl acrylate, and methyl methacrylate.
(4) A mixture of any two or three types selected from the polyvinyl chloride of (1), the chlorinated polyvinyl chloride of (2), and the vinyl chloride copolymer of (3).
(5) A mixture including either: one or two or more selected from the polyvinyl chloride of (1), the chlorinated polyvinyl chloride of (2), and the vinyl chloride copolymer of (3); or the mixture of (4), and further including another resin in an amount of 50% by mass or less. Examples of the another resin include an acrylic resin, an ethylene-vinyl acetate copolymer, a styrene-butadiene copolymer, and a styrene-butadiene-acrylonitrile copolymer.

The vinyl chloride-based resin may contain various additives as necessary. Examples of the additive include a plasticizer, a thermal stabilizer, a photostabilizer (radical scavenger or the like), an ultraviolet absorber (UVA), a surfactant, a coloring agent, a filler, and an antistatic agent. Examples of plasticizers include: phthalate ester-based plasticizers such as dibutyl phthalate, dioctyl phthalate (DOP) and diisononyl phthalate (DINP); adipate ester-based plasticizers such as dioctyl adipate and diisononyl adipate; phosphate ester-based plasticizers such as triphenyl phosphate and tricresyl phosphate; and trimellitate ester-based plasticizers such as tri-2-ethylhexyl trimellitate (TOTM) and tri-n-octyl trimellitate. The plasticizer may be contained in an amount of about 5 to 35 parts by mass with respect to 100 parts by mass of the vinyl chloride-based resin.

The first vinyl chloride-based resin layer contains a coloring agent, and is colored in a desired color such as gray, brown, red, blue, or green. The coloring agent may be selected from various known pigments and dyes. Inorganic pigments such as iron black, yellow lead, titanium yellow, red oxide, cadmium red, ultramarine blue, cobalt blue, etc. and organic pigments or organic dyes such as quinacridone red, isoindolinone yellow, phthalocyanine blue, nickel-azo complexes, azomethine azo-based black pigments, perylene-based black pigments, etc. can be used. Titanium white (titanium oxide particles) can be used, but the content of titanium white should be less than a certain amount (about 1 part by mass, when an amount of the resin component of the first vinyl chloride-based resin layer is 100 parts by mass).

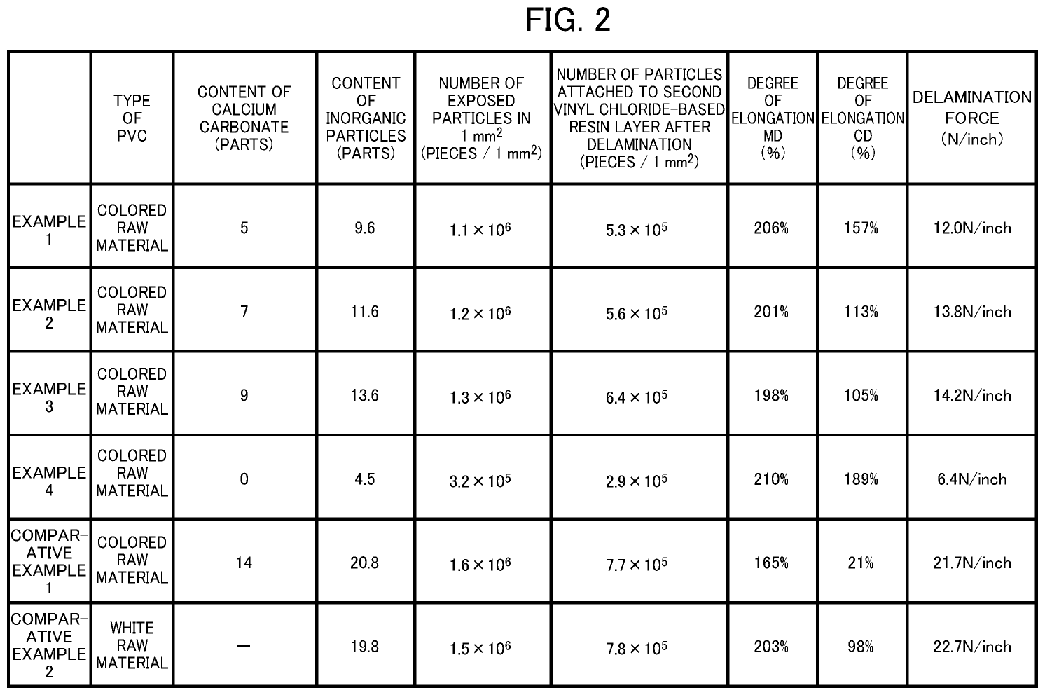

In the Examples and the Comparative Examples described later, a colored film made of vinyl chloride-based resin having a thickness of 150 μm was used as the first vinyl chloride-based resin layer 11. The film contained a vinyl chloride homopolymer having an average polymerization degree of 1500, a plasticizer, a coloring agent, and inorganic particles. As the plasticizer, 20 parts by mass of dioctyl phthalate was used per 100 parts by mass of the vinyl chloride homopolymer. The film was colored gray with a coloring agent. Note that the contents of the inorganic particles and the calcium carbonate particles are shown in FIG. 2. The first vinyl chloride-based resin layers of Examples 1 to 4 and Comparative Example 1 did not contain titanium oxide. The first vinyl chloride-based resin layer of Comparative Example 2 contained 1 part by mass or more of titanium oxide and was colored white.

The first vinyl chloride-based resin layer 11 contains inorganic particles 11a containing calcium carbonate particles, thereby forming a large number of protrusions 11b on the surface thereof. Note that FIG. 1 illustrates an embodiment in which the protrusions 11b protrude only toward the side of the second vinyl chloride-based resin layer 13, but the protrusions 11b may protrude on both sides of the first vinyl chloride-based resin layer 11.

The protrusions protruding on the surface of the first vinyl chloride-based resin layer 11 can be 1.1×10⁶ pieces/mm² or more and 1.3×10⁶ pieces/mm² or less before bonding. The bonding force between the first vinyl chloride-based resin layer 11 and the second vinyl chloride-based resin layer 13 can be increased. Further, the number of protrusions protruding on the surface of the first vinyl chloride-based resin layer 11 can be 4×10⁶ pieces/mm² or more when the decorative sheet is delaminated after bonding and observed. A decorative sheet having good interlayer adhesion can be obtained.

The picture layer 12 is a layer including a picture pattern formed on one surface of the first vinyl chloride-based resin layer 11. The picture layer 12 may be formed when a picture pattern is required, and may not be formed when, for example, only color is required. The picture layer 12 can be formed, for example, by directly printing a picture on the first vinyl chloride-based resin layer 11. The picture layer 12 may be formed by transfer or the like in addition to printing.

In the Examples and the Comparative Examples described later, a pattern of the picture layer 12 was formed by providing a pattern simulating a cut surface of a stone material to the first vinyl chloride-based resin layer 11, using an ink having a vinyl chloride-vinyl acetate copolymer and an acrylic resin mixed by a gravure printing method. Note that a sheet having the picture layer 12 formed on the first vinyl chloride-based resin layer 11 is referred to as a “print sheet”.

The second vinyl chloride-based resin layer 13 includes a vinyl chloride-based resin. The second vinyl chloride-based resin layer 13 is configured to be transparent to some extent by using a transparent or translucent resin, whereby the pattern of the picture layer 12 and the color of the first vinyl chloride-based resin layer 11 can be visually recognized in a satisfactory manner through the second vinyl chloride-based resin layer 13. The surface of the second vinyl chloride-based resin layer 13 may be provided with an uneven pattern 13a. Note that in FIG. 1, an example in which the second vinyl chloride-based resin layer 13 has an uneven pattern 13a in the outermost surface has been described. Other than the above, for example, a surface protective layer formed of a hard coat agent, an overcoat layer which contains a weathering agent such as an ultraviolet absorber, or the like, may be provided on the second vinyl chloride-based resin layer 13.

In the Examples and the Comparative Examples described later, the second vinyl chloride-based resin layer 13 was produced by laminating a transparent film made of a vinyl chloride-based resin having a thickness of 150 μm to the picture layer 12 of the print sheet produced in advance. An embossing plate was pressed by using an embossing machine at the time of bonding, whereby the uneven pattern 13a was formed simultaneously with the bonding of the print sheet and the second vinyl chloride-based resin layer 13. The transparent film contained a vinyl chloride homopolymer having an average polymerization degree of 1500 and a plasticizer. As the plasticizer, 20 parts by mass of dioctyl phthalate was used with respect to 100 parts by mass of the vinyl chloride homopolymer. Note that in the Examples and the Comparative Examples, calcium carbonate particles and titanium oxide particles were not contained in the second vinyl chloride-based resin layer.

The primer layer 14 is provided as necessary in order to assist in bonding the decorative sheet 10 for vacuum forming and the base material as an adherend. The primer layer can be formed by applying a known primer agent to the back surface of the first vinyl chloride-based resin layer 11 (a surface opposite to the second vinyl chloride-based resin layer 13). Examples of the primer agent include a urethane resin primer agent including an acrylic-modified urethane resin and the like, and a primer agent containing a urethane-cellulose-based resin (for example, a resin obtained by adding hexamethylene diisocyanate to a mixture of urethane and nitrified cotton). A thickness of the primer layer 14 is not particularly limited, but may be, for example, 0.1 to 10 μm, and may be about 1 to 5 μm.

In the Examples and Comparative Examples described later, the primer layer 14 was formed by applying a urethane resin-based primer agent to the back surface of the first vinyl chloride-based resin layer 11 after the embossing process (adhesion process).

FIG. 2 is a diagram comparing the Examples of the decorative sheet 10 for vacuum forming of the present embodiment with Comparative Examples. In Examples 1 to 4 and Comparative Example 1, as the raw material of the first vinyl chloride-based resin layer, a film (referred to as a colored raw material in FIG. 2) colored without using titanium oxide particles was used. In Examples 1 to 4, the raw material of the first vinyl chloride-based resin layer contained calcium carbonate particles, whereas in Comparative Example 1, the raw material of the first vinyl chloride-based resin layer did not contain calcium carbonate particles. In Comparative Example 2, a film colored white using titanium oxide particles (referred to as white raw material in FIG. 2) was used as the raw material of the first vinyl chloride-based resin layer. These Examples and Comparative Examples had the same configuration except that the raw materials of the first vinyl chloride-based resin layer were different.

The term “the number of exposed particles” in FIG. 2 is a result of counting the number of protruding particles (the number of protrusions 11b) per 1 mm² by observing the surface of the first vinyl chloride-based resin layer before bonding, with a microscope.

The “number of particles attached to the second vinyl chloride-based resin layer after delamination” in FIG. 2 is a result by observing a surface (delamination surface) of the second vinyl chloride-based resin layer on the first vinyl chloride-based resin layer 11 side after measurement of a delamination force described later, and counting the number of particles attached to the delamination surface per 1 mm².

A degree of elongation MD (machine direction) and a degree of elongation CD (cross machine direction) in FIG. 2 each indicate a degree of elongation when the first vinyl chloride-based resin layer (or white vinyl chloride-based resin layer) alone is pulled in the designated direction at an ambient temperature.

Measured values of the delamination force in FIG. 2 are each a measurement result of a sample reproducing a state after vacuum forming. Reproduction of the state after vacuum forming is carried out by heating a sample of the decorative sheet for vacuum forming to 70° C., while keeping the temperature, pulling the decorative sheet by 300% in the MD direction, and then cooling it to an ambient temperature (20° C.). FIG. 2 shows the measurement results of the delamination force between the first vinyl chloride-based resin layer and the second vinyl chloride-based resin layer of the sample reproducing the state after vacuum forming (conditions: delamination direction: 180°; and delamination speed: 100 mm/min). Higher delamination force values mean better adhesion between the layers, and the layers can be said to be less likely to delaminate during vacuum film formation.

The decorative sheets of Examples 1 to 4 have good adhesion between the layers. Here, note that the target value of the delamination force was 10 N/inch. Therefore, the first vinyl chloride-based resin layer and the second vinyl chloride-based resin layer do not easily delaminate during vacuum forming. In contrast, the decorative sheet of Comparative Example 1 had insufficient adhesion between the layers. Therefore, there is a likelihood of delamination between the first vinyl chloride-based resin layer and the second vinyl chloride-based resin layer during vacuum forming. Note that the decorative sheet of Comparative Example 2 had good adhesion between the layers, but the design by the picture layer was lighter than desired.

The decorative sheets of Examples 1 to 3 are further excellent in the degree of elongation. Therefore, their suitability to the vacuum forming method was superior to that of the decorative sheet of Example 4.

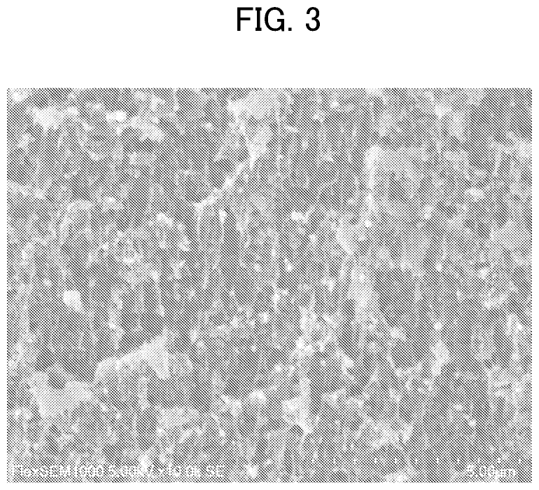

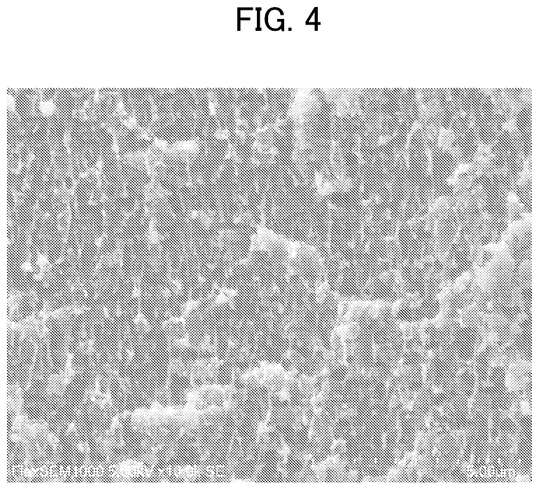

The reason why calcium carbonate particles contained in the first vinyl chloride-based resin layer result in good adhesion between the first vinyl chloride-based resin layer and the second vinyl chloride-based resin layer in Examples 1 to 4 was assumed to be that at least a portion of the protrusions 11b encroach (penetrate) into the second vinyl chloride-based resin layer, because the first vinyl chloride-based resin layer contains the calcium carbonate particles. Given the above, with respect to the decorative sheets of Example 2 and Comparative Example 1, the second vinyl chloride-based resin layer was delaminated from the first vinyl chloride-based resin layer 11 and the surface of the second vinyl chloride-based resin layer having been bonded to the first vinyl chloride-based resin layer was photographed. FIG. 3 is a photograph of the delamination surface of the second vinyl chloride-based resin layer 13 after delamination in Example 2. FIG. 4 is a photograph of the delamination surface of the second vinyl chloride-based resin layer 13 after delamination in Comparative Example 1.

As shown in FIGS. 3 and 4, particles were attached to the surface of the second vinyl chloride-based resin layer which originally should have included few particles. Further, the number of particles adhering to the surface of the second vinyl chloride-based resin layer was larger in Example 2 in which the content of the inorganic particles in the first vinyl chloride-based resin layer was large, than in Comparative Example 1 in which the content of the inorganic particles in the first vinyl chloride-based resin layer was small. These observation results support the inference that the adhesion between the second vinyl chloride-based resin layer and the first vinyl chloride-based resin layer was improved by the encroachment(penetration) of the particles of the first vinyl chloride-based resin layer into the second vinyl chloride-based resin layer.

### EXPLANATION OF REFERENCE NUMERALS

10 Decorative sheet for vacuum forming
11 First vinyl chloride-based resin layer
11a Inorganic particles
11b Protrusions
12 Picture Layer
13 Second vinyl chloride-based resin layer
13a Unevenness pattern
14 Primer layer

1. A decorative sheet for vacuum forming, comprising:
a first vinyl chloride-based resin layer comprising a vinyl chloride-based resin and a coloring agent; and
a second vinyl chloride-based resin layer laminated on the first vinyl chloride-based resin layer, the second vinyl chloride-based resin layer comprising a vinyl chloride-based resin,
the first vinyl chloride-based resin layer comprising no titanium oxide particles, or the content of titanium oxide particles in the first vinyl chloride-based resin layer being less than 1 part by mass;
the first vinyl chloride-based resin layer comprising inorganic particles, at least a portion of the inorganic particles being calcium carbonate particles.

2. The decorative sheet for vacuum forming according to claim 1,
wherein a surface of the first vinyl chloride-based resin layer, the surface being closer to the second vinyl chloride-based resin layer, has protrusions caused by the inclusion of the calcium carbonate particles; and
at least a portion of the protrusions encroach into the second vinyl chloride-based resin layer.

3. The decorative sheet for vacuum forming according to claim 1,
wherein a picture layer is disposed between the first vinyl chloride-based resin layer and the second vinyl chloride-based resin layer.

4. The decorative sheet for vacuum forming according to claim 1,
wherein the first vinyl chloride-based resin layer comprises 8 parts by mass or more of the inorganic particles with respect to a resin component.

5. The decorative sheet for vacuum forming according to claim 4,
wherein the first vinyl chloride-based resin layer comprises 3 parts by mass or more of the calcium carbonate particles with respect to the resin component.

6. The decorative sheet for vacuum forming according to claim 4,
wherein the first vinyl chloride-based resin layer comprises 16 parts by mass or less of the inorganic particles with respect to the resin component.

7. The decorative sheet for vacuum forming according to claim 6,
wherein the first vinyl chloride-based resin layer comprises 11 parts by mass or less of the calcium carbonate particles with respect to the resin component.

8. A method for manufacturing a decorative material,
the method including:
providing a base material formed into a three-dimensional shape and the decorative sheet for vacuum forming according to claim 1,
softening the decorative sheet by heating, and
allowing the softened decorative sheet to be vacuum-adsorbed into the three-dimensional shape of the base material through a pressure reducing operation.

9. A decorative material,
comprising a base material formed into a three-dimensional shape and
the decorative sheet for vacuum forming according to claim 1, the decorative sheet being bonded following the three-dimensional shape of the base material,
the second vinyl chloride-based resin layer of the decorative sheet for vacuum forming, the first vinyl chloride-based resin layer of the decorative sheet for vacuum forming, and the base material being laminated in this order.
